(19) United States
(12) Patent Application Publication
(10) Pub. No.: US 2022/0013928 A1
(43) Pub. Date: Jan. 13, 2022

(54) Cable assembly and method of joining cables

(71) Applicant: NEXANS, Courbevoie (FR)

(72) Inventors: Robin SANGAR, DROBAK (NO); Audun JOHANSON, OSLO (NO); Mats JOHANSSON, STROMSTAD (SE); Alf Erik ROD, HALDEN (NO); Brynjar JACOBSEN, HALDEN (NO)

(21) Appl. No.: 17/338,371

(22) Filed: Jun. 3, 2021

(30) Foreign Application Priority Data
Jun. 19, 2020 (EP) 20 305 677.5

(51) Int. Cl. H01R 4/30

(52) U.S. Cl. CPC H01R 4/308

(57) ABSTRACT

A cable assembly (100) is provided having a first cable (20) having a first conductor (22), a second cable (40) having a second conductor (42) and an electrically conducting joining element (60). The joining element (60) comprises a first threaded end section (61) and a second threaded end section (62) opposite of the first end section (61. The first threaded end section (61) is connected to the first conductor (22). The second threaded end section (62) is connected to the second conductor (42). The present invention also relates to a method for joining a first cable (20) having a first conductor (22) and a second cable (40) having a second conductor (42).

### RELATED APPLICATION

This application claims the benefit of priority from European Patent Application No. 20 305 677.5, filed on Jun. 19, 2020, the entirety of which is incorporated by reference.

### FIELD OF THE INVENTION

The present invention relates to a cable assembly comprising a first cable having a first conductor, a second cable having a second conductor and an electrically conducting joining element. The present invention also relates to a method for joining a first cable having a first conductor and a second cable having a second conductor.

### BACKGROUND OF THE INVENTION

Electric power cables must often be joined. One example of the conductor of such a prior art cable is shown in FIG. 1. The conductor is typically made from copper or aluminum and consists of a circular center wire 124 surrounded by concentric layers 125a-e of stranded, typically keystone-shaped wires 126, resulting in a very compact conductor with a smooth surface. The strands are wound in a spiral, with the layers being wound in alternating directions, e.g. the first layer is wound in a clockwise spiral, the next layer wound in a counter clockwise spiral and so on. The configuration of central wire/stranded wires provides the cable with improved flexibility. The above conductor is surrounded by a plurality of insulating/protective layers (not shown in FIG. 1).

Sections of the above power cables must in some situations be joined together to form one single power cable.

In US 2018/0375223 (Nexans), one method is disclosed. Here, the stranded wires of each cable end are unwound and pulled back to expose the ends of each layer and the central rod, then a connection piece is thermally joined between the ends of the central rod of each cable. Then the stranded wires of each layer of the two cables are rewound and thermally joined to each other outside each other. In a final step, insulating/protective layers are added outside of the joining area of the two cables.

In FIG. 2, it is shown how the stranded wires of two conductors 122, 142 are unwound and pulled back. This method is very time-consuming.

The object of the present invention is to provide a more time-efficient method of creating a transition joint between two cables. Another object of the present invention is to provide a method of creating a flexible transition joint between two cables. Another object of the present invention is to provide a method of creating a transition joint between two different cables.

### SUMMARY OF THE INVENTION

The present invention relates to a cable assembly comprising a first cable having a first conductor, a second cable having a second conductor and an electrically conducting joining element;

characterized in that

the joining element comprises a first threaded end section and a second threaded end section opposite of the first end section;

wherein the first threaded end section is connected to the first conductor;

wherein the second threaded end section is connected to the second conductor.

In one aspect, the first threaded end section is connected to an opening provided in the first conductor; and the second threaded end section is connected to an opening provided in the second conductor.

In one aspect, the first and second openings are threaded openings. Alternatively, the first and second openings are initially non-threaded openings, where grooves are created in the first and second openings during connection of the first and second threaded end sections to their respective opening.

In one aspect, the first and second openings are aligned with the central longitudinal axis of the first and second conductors.

In one aspect, the first threaded end section and the second threaded end section are screwed into the respective cable conductors when the joining element is rotated in a first direction relative to both the first and second conductors.

In this way, the first and/or second cables do not need to be rotated during the assembly process, and the joining element becomes connected to both the first and second conductors simultaneously.

In one aspect, the joining element comprises an intermediate section axially between the first threaded end section and the second threaded end section.

In one aspect, the intermediate section has an outer diameter corresponding to the outer diameter of the first and/or second conductor.

In one aspect, the intermediate section comprises a tool interface for rotating the joining element relative to both the conductors simultaneously.

In one aspect, the outermost layer of the first conductor comprises a first step profile; the outermost layer of the second conductor comprises a second step profile, wherein the cable assembly further comprises a sleeve section surrounding the first step profile and the second step profile.

Hence, the sleeve section is provided circumferentially outside the first step profile and the second step profile.

In one aspect, the sleeve section is separate from the joining element.

In one aspect, the sleeve section is connected to the intermediate section of the joining element.

In one aspect, the intermediate section of the joining element has a diameter equal to the diameter of one of the conductors.

In one aspect, the sleeve section comprises a tool interface for rotating the joining element relative to both of the conductors.

In one aspect, the first and second conductors are connected to each other directly and/or via the joining element by means of additional fastening means, such as mechanical bonding, an adhesive or welding.

The present invention also relates to a method for joining a first cable having a first conductor and a second cable having a second conductor; wherein the method comprises the steps of:

providing an electrically conducting joining element comprising a first threaded end section and a second threaded end section opposite of the first end section;

screwing the first threaded end section into the first conductor;—screwing the second threaded end section into the second conductor.

In one aspect, the method further comprises the steps of:

providing a first opening in the first conductor;

providing a second opening in the second conductor;

wherein the screwing steps comprises:

screwing the first threaded end section into the first opening; and

screwing the second threaded end section into the second opening.

In one aspect, the steps of providing openings comprise the steps of providing threaded openings.

In one aspect, the steps of screwing the first threaded end section into the first conductor and screwing the second threaded end section into the second conductor comprises the step of:

rotating the joining element in a first direction relative to both the first and second cable conductors.

In one aspect, the steps of screwing of the first threaded end section into the first conductor and the screwing of the second threaded end section into the second conductor is performed simultaneously.

In one aspect, the first and second openings are aligned with the central longitudinal axis of the first and second conductors.

In one aspect, the method further comprises the steps of:

providing the joining element with an intermediate section axially between the first threaded end section and the second threaded end section, the intermediate section comprising a tool interface.

In one aspect, the method further comprises the steps of:

providing the outermost layer of the first conductor with a first step profile;

providing the outermost layer of the second conductor with a second step profile;

providing a sleeve section circumferentially outside of the first step profile and the second step profile.

In one aspect, the method comprises the steps of:

providing the sleeve section as a part of the joining element by connecting the sleeve section to the intermediate section.

In one aspect, the method further comprises the steps of:

providing the sleeve section with a tool interface;

rotating the joining element relative to one of or both conductors by means of a tool interfacing with the tool interface.

The present inventions are used to join two high voltage cables at a flexible transition joint. In the context of the invention, the term “flexible” means that the transition joint has essentially the same or equal handling capabilities as non-spliced sections of the cable itself under intended use scenarios for the cable. For example, a section of cable comprising a “flexible” transition joint according to the invention may be transported, installed or handled in the same manner as non-spliced sections of the cable without the need for additional or different equipment or handling procedures.

The term “central wire” or “centre wire” refers to the innermost wire of the conductor. The central wire may be referred to as a centre rod.

The term “stranded wires” refers to the relatively thinner (compared to the central wire) wires wrapped about the central wire. In one embodiment, the stranded wires have a keystone shaped cross section. Alternatively, the stranded wires may be round wires or compressed round wires.

The stranded wires are wrapped about the central wire in a spiral in layers comprising an integer number of strands per layer. The term “first layer” refers to the innermost layer of strands. The next innermost layer is referred to as the “second layer” and so forth. The outermost layer may be alternatively referred to by its ordinal position, or merely by the term “outer layer” or “outermost layer” of strands. The strands of different layers of the same cable may have different thicknesses, and the corresponding layers of the two cables may or may not contain an equal number of strands. The strands of a given layer travel together in tandem, adjacent to one another, in a spiral about the central wire. The layers alternate in the direction of the spiral.

### BRIEF DESCRIPTION OF THE DRAWINGS

In the following, specific embodiments of the invention will be described in more detail with reference to the drawings; where:

FIG. 1 illustrates a perspective view of an end of a prior art power cable;

FIG. 2 illustrates a perspective view of the unwinding step of a prior art method of joining two cables;

FIG. 3 illustrates a side view of the respective ends of two cables to be joined;

FIG. 4 illustrates a first step of the joining process;

FIG. 5 illustrates a second step of the joining process;

FIG. 6 illustrates a third step of the joining process;

FIG. 7 illustrates the cable assembly of the two joined cables;

FIG. 8 illustrates a side view an alternative joining element;

FIG. 9 illustrates a perspective view of the alternative joining element and one of the cable ends;

FIG. 10 illustrates two cables being joined with the alternative joining element;

FIGS. 11 and 12 illustrate an alternative embodiment to FIG. 8 and FIG. 9;

FIG. 13 illustrates yet an alternative embodiment;

FIG. 14 illustrates the two conductors of FIG. 13 being connected.

### DETAILED DESCRIPTION

### Example 1

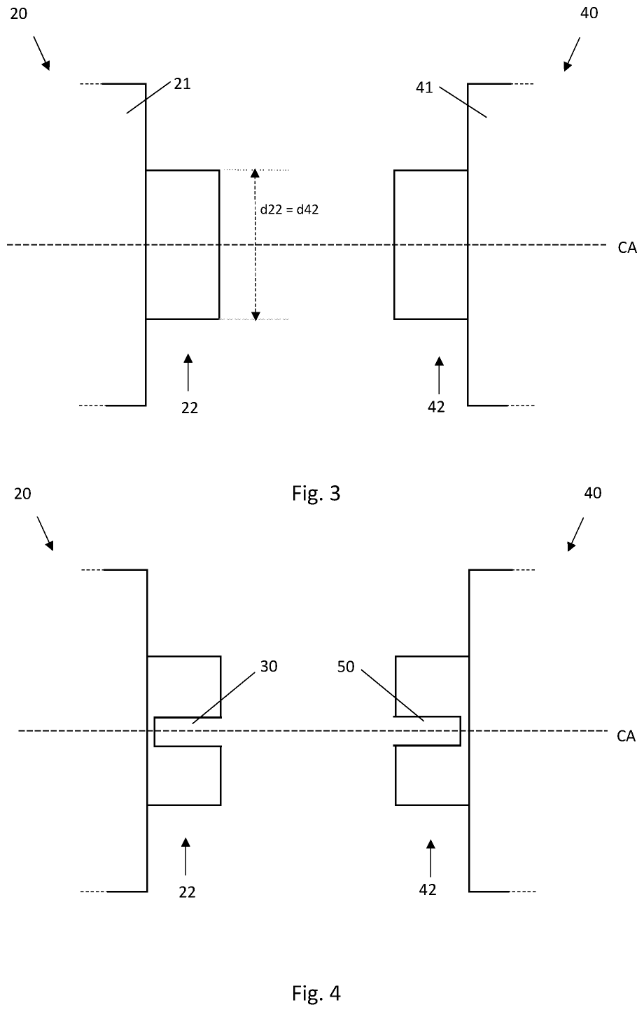

It is now referred to FIG. 3, showing an end of a first cable 20 and an end of a second cable 40 which are to be assembled into a cable assembly 100.

The first cable 20 comprises a first conductor 22 and one or more insulating layers 21, where a part of the insulating layers 21 has been removed to obtain access to a length of the conductor 22.

Similarly, the second cable 40 comprises a second conductor 42 and one or more insulating layers 41, where a part of the insulating layers 41 has been removed to obtain access to a length of the conductor 42.

The first and second cables 20, 40 are here of the same type and has the same diameter, as indicated as diameter d22 for the first conductor and diameter d42 for the second conductor 42. The central longitudinal axis CA is indicated in FIG. 3.

It is now referred to FIG. 3. Here, it is shown that a first opening 30 has been provided in the first conductor 22 and that a second opening 50 has been provided in the second conductor 42. The openings 30, 50 are aligned with the axis CA. The openings 30, 50 are shown to be non-threaded, but it is also possible to provide them as threaded openings.

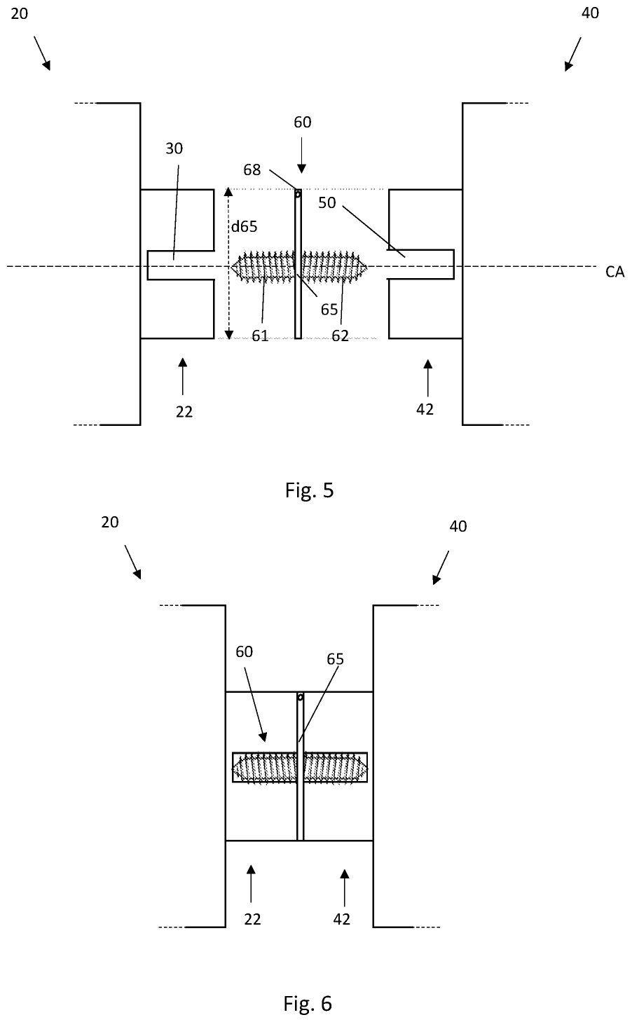

It is now referred to FIG. 5. Here, a joining element 60 is shown between the first and second cables 20, 40. The joining element 60 comprises two ends sections 61, 62 and an intermediate section 65 between the two end sections. Hence, the intermediate section 65 is provided axially, i.e. in the direction of the axis CA, between the first threaded end section 61 and the second threaded end section 62.

The first end section is a threaded end section 61 adapted to be connected or screwed into the first opening 30. The second end section is a threaded end section 62 adapted to be connected or screwed into the second opening 50. Hence, the end sections 61, 62 are provided in opposite ends relative to the intermediate section 65.

The intermediate section 65 here has an outer diameter d65 corresponding to the outer diameters d22, 42 of the first and/or second conductor 22, 42.

In one aspect, the intermediate section 65 comprises a tool interface 68 for rotating the joining element 60 relative to both the conductors 22, 42. The tool interface 68 may be a wrench interface for a wrench-type of tool, it may be a bore for a pin-type of tool etc. The purpose here is to be able to rotate the joining element 60 relative to the first and second cables 20, 40, so that any movement between the cables during the assembly process can be reduced.

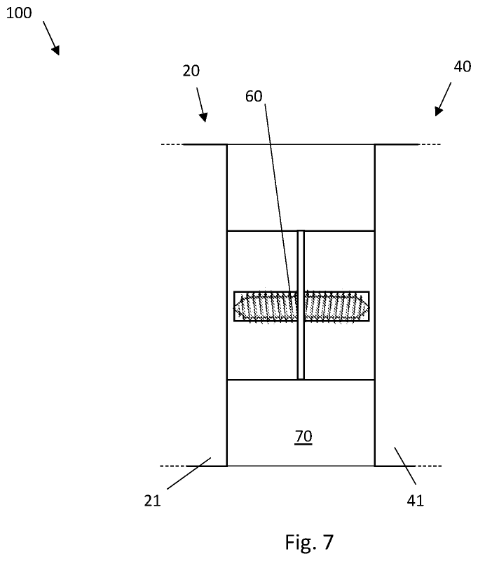

It is now referred to FIG. 6. Here it is shown that the conductors 22, 42 have been mechanically and electrically connected to each other by means of the electrically conductive joining element into an assembled conductor of the cable assembly 100. Due to the diameter of the intermediate section 65 and the diameter of the conductors 22, 42, the intermediate section 65 and conductors are preferably flush with each other so as to obtain a smooth outer surface of the assembled conductor. Of course, the tool interface 68 may cause the outer surface of the assembled conductor to be somewhat uneven. If considered needed, the unevenness may be smoothed.

It is now referred to FIG. 7. In a final step, a protective/insulative layer 70 is provided radially outside of the ends of the conductors 22, 42 and the joining element 60. The protective/insulative layer 70 is typically joined with the protective/insulative layers 21, 41 of the first and second cables 20, 40. The joining process of protective/insulative layers to obtain the desired mechanical properties and desired insulative properties are considered known and will not be described herein further in detail.

### Example 2

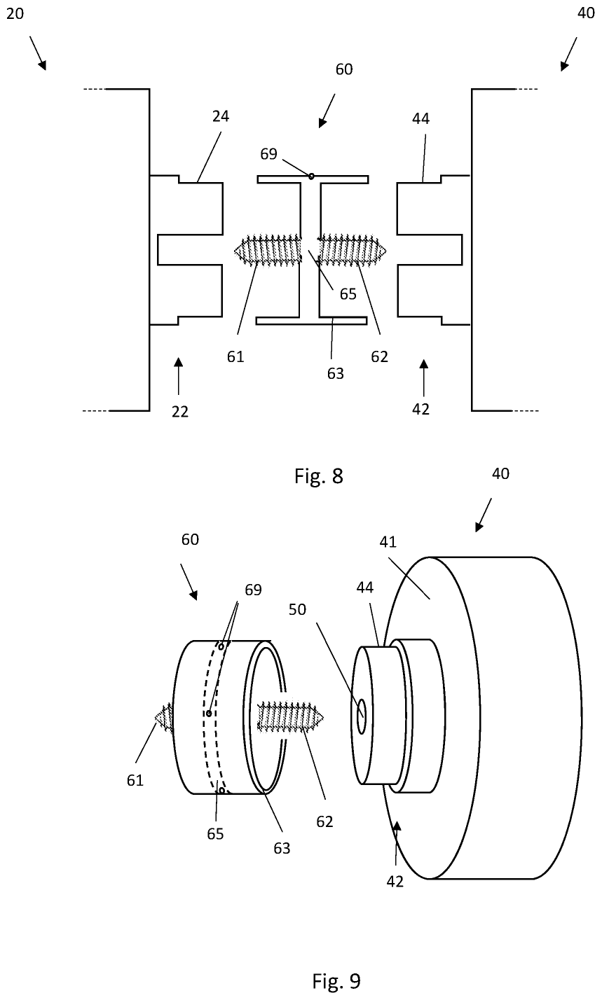

It is now referred to FIGS. 8 and 9. The second example has many similarities with the first example above, and only differences between the second and first examples will be described in detail below.

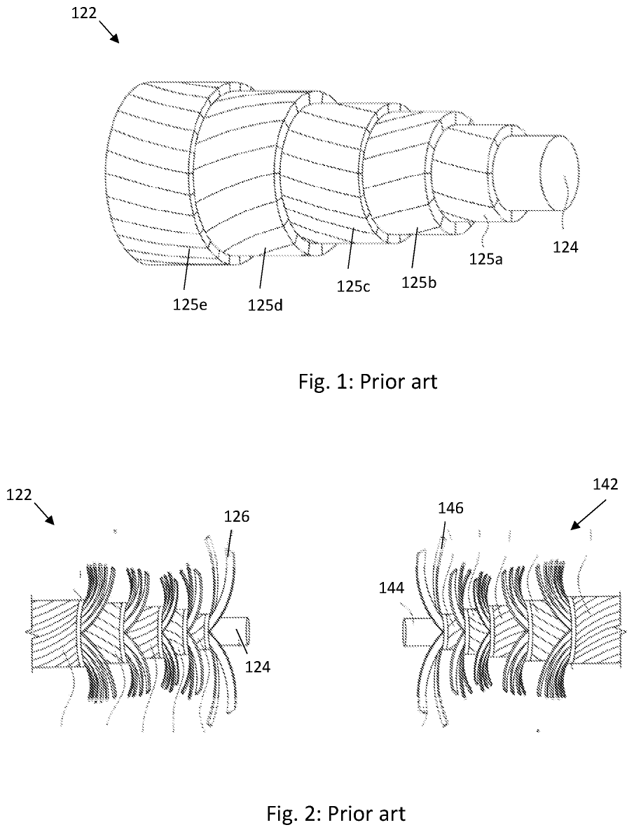

First, a part of the outermost layer of the first conductor 22 has been removed to form a first step profile 24 and a part of the outermost layer of the second conductor 42 has been removed to form a second step profile 44. The length of the lowered steps 24, 44 may typically be from one to a couple of centimeters, while the lowered steps 24, 44 will have a diameter 0.1-1.0 cm shorter than the diameter d22, 42 of the conductors as indicated in FIG. 1.

Second, the joining element 60 comprises a sleeve section 63 adapted to surround the first step profile 24 and the second step profile 44. The sleeve section 63 is connected to the intermediate section 65 of the joining element 63. Here, the intermediate section 65 does not comprise a tool interface 68. However, the sleeve section 63 comprises a tool interface 69 for rotating the joining element 60 relative to both of the conductors 22, 42.

It should be noted that in FIG. 9, the intermediate section 65 is indicated by dashed lines on the outside of the sleeve section 63.

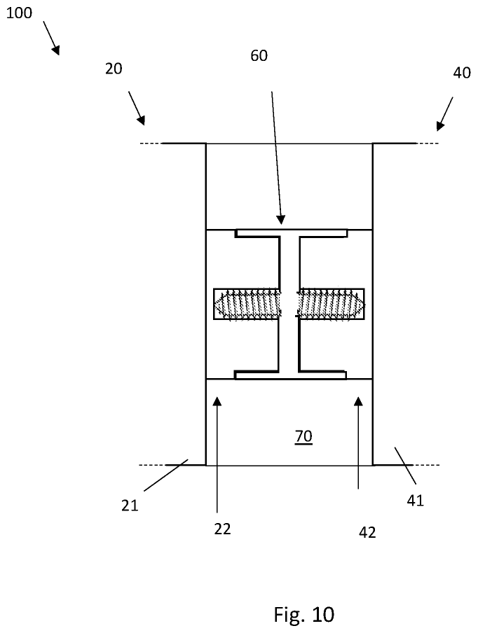

The cable assembly 100 is shown in FIG. 10. As the sleeve section 63 of the joining element 60 is provided circumferentially outside the first step profile 24 and the second step profile 44, the conductors and joining element together form a flush assembled conductor.

An external press can be used to both increase the assembled conductor surface smoothness and increase the mechanical strength of the joint by applying external radial pressure on the outside of the first conductor, the joining element and the second conductor.

### Example 3

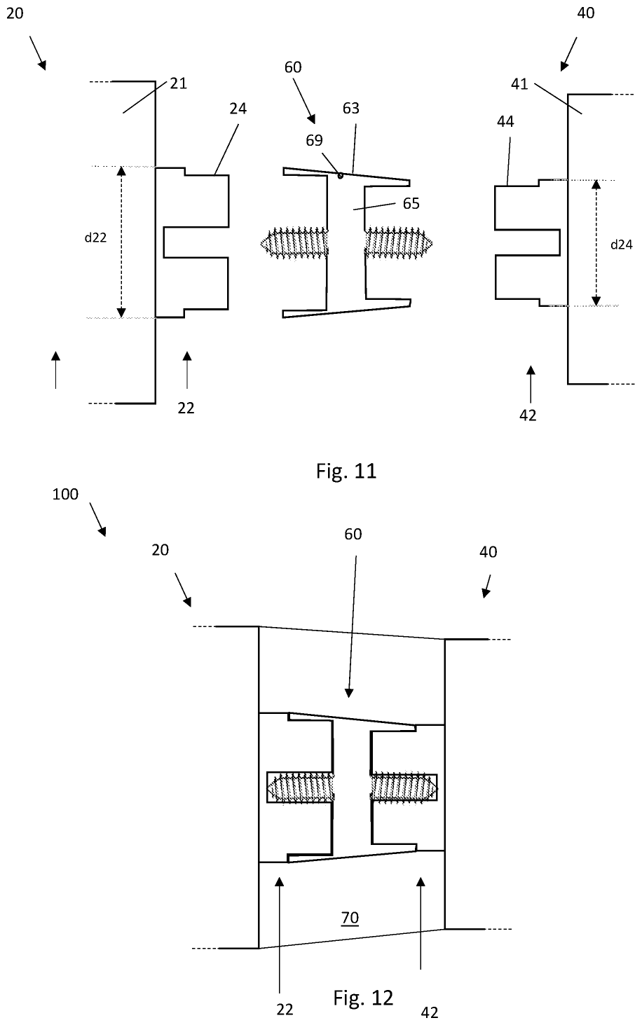

It is now referred to FIG. 11. Again, the third example has similarities with the first and second examples above, and only differences between the third example and the first/second examples will be described in detail below.

In this example, the first conductor 22 has a diameter d22 being smaller than the diameter d42 of the second conductor 42. Also the outer diameter of the first cable 20 is smaller than the diameter of the second cable 40.

Similar to the second example above, the ends of the conductors 22, 42 have step profiles 24, 44. The joining element 60 comprises a sleeve section 63 adapted to surround the step profiles 24, 44. However, due to the different diameters d22, d44, the outer shape of the sleeve section 63 is conical, also here causing a smooth transition between the first and second conductors 22, 42.

In FIG. 12, the cable assembly 100 is shown.

### Example 4

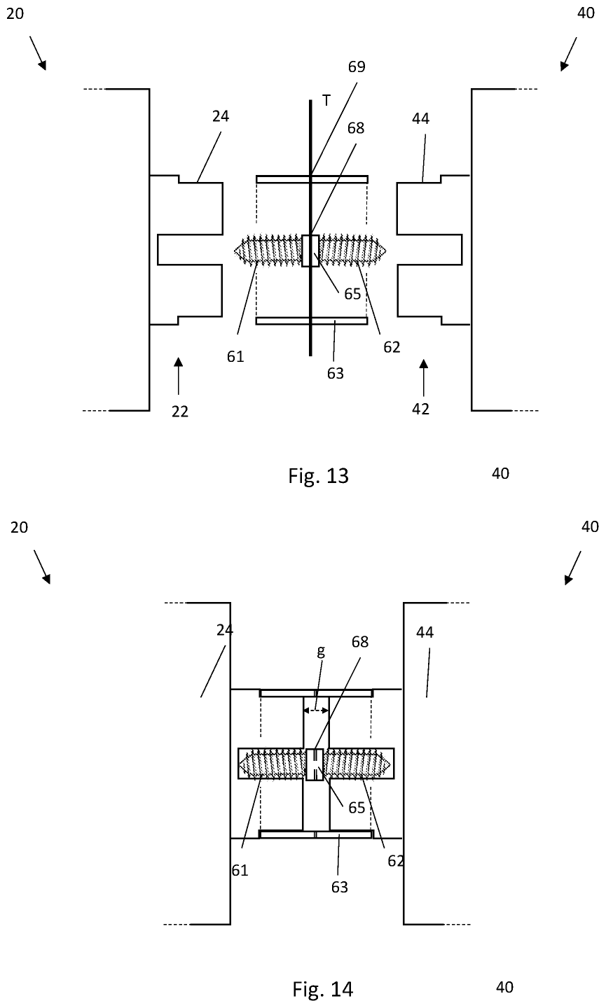

It is now referred to FIG. 13. Again, the fourth example has similarities with the first, second and third examples above, and only differences between the fourth example and the first/second/third examples will be described in detail below.

In this example, the sleeve section 63 is not connected to the intermediate section 65 of the joining element 61, i.e. the sleeve section 63 is an element separate from the joining element 63. It is still possible to use a tool to rotate the joining element 61 relative to the conductors 22, 42. As an example, the tool T may be a relatively thin rod inserted radially through the sleeve section 63 and the intermediate section 65 of the joining element 65. By rotating the rod, the threaded end sections 61, 62 will be screwed into the openings in the conductors and the ends of the conductors will be pulled towards each other until they meet the tool T. Hence, there will be a small gap g (exaggerated in FIG. 14) between the ends of the first and second conductors. This gap g may be filled with molten metal, an electrically conductive and preferably adhesive paste etc., via the openings for the tool T in the sleeve section 63.

### Alternative Embodiments

In the above embodiments, openings 30, 50 were provided in the conductors 22, 42 before the joining element 60 was screwed into the openings. It is also possible to screw the joining elements 60 directly into conductors 22, 42 if the joining element 60 and the conductors 22, 42 are made of materials allowing this. For example, if the conductors 22, 42 are made of an aluminium or copper alloy, a screw made of steel or hardened steel may be screwed directly into the aluminium or copper alloy.

Here, spiral-shaped grooves or threads will be created in the first and second openings 30, 50 during connection of the first and second threaded end sections 61, 62 to their respective opening 30, 50.

It should be noted the above examples may be combined with other methods and means for joining two cables into a cable assembly. For example, the inner rods 124, 144 of the prior art cables of FIG. 2 may be connected to each other by means of a joining element described above, while the outer layers are connected by prior art methods.

It would also be possible to use a welding process to weld the sleeve section 63 to the conductors 22, 42.

Other types of fasteners, adhesives etc. may also be used to improve the mechanical and/or electrical purposes of the cable assembly of the above examples.

It should be noted that in the above examples, the threaded end sections 61, 62 may have a conical shape, i.e. that the area close to the tip of the end sections have a relatively smaller diameter than the area close to the intermediate section. Hence, the threaded end sections may be mechanically and electrical in contact not only with the center element of the conductor, but also with the stranded wires of the conductor.

1. Cable assembly comprising:
a first cable having a first conductor, a second cable having a second conductor and an electrically conducting joining element;
wherein the joining element comprises a first threaded end section and a second threaded end section opposite of the first end section;
wherein the first threaded end section is connected to the first conductor;
wherein the second threaded end section is connected to the second conductor
wherein the first threaded end section is connected to an opening provided in the first conductor; and wherein the second threaded end section is connected to an opening provided in the second conductor.

2. The cable assembly according to claim 1, wherein the first threaded end section and the second threaded end section are screwed into the respective cable conductors when the joining element is rotated in a first direction relative to both the first and second conductors.

3. The cable assembly according to claim 1, wherein the joining element comprises an intermediate section axially between the first threaded end section and the second threaded end section.

4. The cable assembly according to claim 1, wherein the outermost layer of the first conductor comprises a first step profile;
the outermost layer of the second conductor comprises a second step profile,
wherein the cable assembly further comprises a sleeve section surrounding the first step profile and the second step profile.

5. The cable assembly according to claim 4, wherein the sleeve section is connected to the intermediate section of the joining element.

6. The cable assembly according to claim 1, wherein the intermediate section of the joining element has a diameter equal to the diameter of one of the conductors.

7. The cable assembly according to claim 7, wherein the sleeve section comprises a tool interface for rotating the joining element relative to both of the conductors.

8. The cable assembly according to claim 1, wherein the first and second conductors are connected to each other directly and/or via the joining element by means of additional fastening means, such as mechanical bonding, an adhesive or welding.

9. A method for joining a first cable having a first conductor and a second cable having a second conductor; wherein the method comprises the steps of:
providing an electrically conducting joining element comprising a first threaded end section and a second threaded end section opposite of the first end section;
screwing the first threaded end section into the first conductor;
screwing the second threaded end section into the second conductor.
wherein the method further comprises the steps of:
providing a first opening in the first conductor;
providing a second opening in the second conductor;
wherein the screwing steps comprises:
screwing the first threaded end section into the first opening; and
screwing the second threaded end section into the second opening.

10. The method according to claim 9, wherein the steps of screwing the first threaded end section into the first conductor and screwing the second threaded end section into the second conductor comprises the step of:
rotating the joining element in a first direction relative to both the first and second cable conductors.

11. The method according to claim 9, wherein the method further comprises the steps of:
providing the joining element with an intermediate section axially between the first threaded end section and the second threaded end section, the intermediate section comprising a tool interface.

12. The method according to claim 9, wherein the method further comprises the steps of:
providing the outermost layer of the first conductor with a first step profile;
providing the outermost layer of the second conductor with a second step profile;
providing a sleeve section circumferentially outside of the first step profile and the second step profile.

13. The method according to claim 12, wherein the method comprises the steps of:
providing the sleeve section as a part of the joining element by connecting the sleeve section to the intermediate section.
